(19) United States
(12) Patent Application Publication
(10) Pub. No.: US 2014/0227576 A1
(43) Pub. Date: Aug. 14, 2014

(54) Single Cell and Battery Made of a Plurality of Single Cells

(71) Applicants: Jens Meintschel, Bernsdorf (DE); Dirk Schroeter, Winnenden (DE)

(72) Inventors: Jens Meintschel, Bernsdorf (DE); Dirk Schroeter, Winnenden (DE)

(73) Assignee: Daimler AG, Stuttgart (DE)

(21) Appl. No.: 14/236,234

(22) PCT Filed: Jul. 18, 2012
(86) PCT No.: PCT/EP2012/003024

§ 371 Date: Mar. 19, 2014

(30) Foreign Application Priority Data
Aug. 2, 2011 (DE) 10 2011 109 218.1

(51) Int. Cl. H01M 2/20; H01M 10/613; H01M 2/30

(52) U.S. Cl. CPC H01M 2/206; H01M 2/30; H01M 10/5004; H01M 2220/20
USPC 429/120; 429/178; 429/158

(57) ABSTRACT

A single cell for a battery includes an electrode stack situated within a cell housing formed from two electrically conductive shell-shaped housing side walls situated essentially in parallel opposite one another, having a shell flange extending around the edges. The shell flanges are joined to one another to form a flange area and are electrically insulated from one another. Pole contact tabs of the electrode stack are connected electrically connected to the housing side walls. At least one of the housing side walls has a section protruding, at least in parts, beyond the flange area of at least one housing edge of the cell housing. The protruding section of the housing side wall is angled in the direction of a cell interior and in the direction of a shell base of the housing side wall, and in the angled state protrudes beyond the shell base by a predetermined amount.

### BACKGROUND AND SUMMARY OF THE INVENTION

Exemplary embodiments of the invention relate to a single cell for a battery a battery composed of a plurality of single cells.

Batteries, in particular high-voltage batteries for use in a vehicle, are known from the prior art, having a plurality of single cells connected in a row and/or in series. The single cells together with a control and/or evaluation electronics system and a cooling device are generally situated in a shared battery housing. Various designs of the single cells are known and in use.

Customary bipolar flat-frame cells are preferably used as single cells. Such a cell is enclosed by two planar metallic enveloping metal sheets. In one preferred embodiment, at least one of these enveloping metal sheets may have a dish-shaped design. The housing side walls are separated from one another by an electrically insulating frame, and at the same time are used as poles of the single cell for introducing or withdrawing electrical power. The heat loss from the single cell is conducted via the correspondingly thickened enveloping metal sheets or housing side walls to a narrow side of the single cell and delivered to a cooling plate through which air conditioning refrigerant or a cooling liquid flows. In order to electrically insulate the enveloping metal sheet or housing side wall and the metallic cooling plate, which is preferably provided with channels for a cooling medium, a thermally conductive foil is situated in between. Enveloping metal sheets or a housing side wall in the area of the cooling plate are bent down by 90° parallel to the cooling plate as a cooling tab in order to improve the heat transfer. In addition, heating of the single cell if needed, for example at low outside temperatures, is made possible via this heat-conductive path. For this purpose, a heated cooling medium, for example, flows through the metallic cooling plate.

A hot pressing process is preferably used to close off the single cell. For this purpose, frames or portions thereof are made of a thermoplastic material, at least in the area of a sealing seam.

The electrochemically active portion of the single cell is the electrode stack or winding, which is formed by layers of cathode and anode foils which in each case are separated by separator layers. For example, coated aluminum and copper films are used for a lithium-ion cell. Anode and cathode films are uncoated, at least at one edge, and protrude from the electrode stack in a tab-like manner and are connected to one another to form a current discharge tab. The current discharge tabs are connected to the inner side of the enveloping metal sheet or the inner side of the housing side wall to enable electrical coupling. For this purpose, conventional pressure welding or fusion welding processes, for example resistance spot welding, ultrasonic welding, or laser welding, are used. Alternatively or additionally, a positive-fit connection, for example a riveted joint, may be provided.

In one possible design, the bipolar flat-frame cells are electrically connected in series by welding the enveloping metal sheets or the housing side walls of the single cells adjacently situated in the cell block. For this purpose, the top sides of the enveloping metal sheets or of the housing side walls are provided with tongue-like extensions that protrude beyond the enveloping contour of the single cell and are joined, for example, by a pressure welding process.

Exemplary embodiments of the present invention are directed to an improved single cell for a battery, and a battery composed of a plurality of single cells that is improved over the prior art.

In the single cell for a battery, having an electrode stack situated within a cell housing, the cell housing being formed from two electrically conductive shell-shaped housing side walls situated essentially in parallel opposite one another, having a shell flange extending around the edges, the shell flanges being joined to one another in an integrally bonded manner to form a flange area and being electrically insulated from one another, and pole contact tabs of the electrode stack being connected to the housing side walls in an electrically conductive manner, according to the invention at least one of the housing side walls has a design which protrudes, at least in parts, beyond the flange area of at least one housing edge of the cell housing, the section of the housing side wall protruding beyond the flange area being angled in the direction of a cell interior and in the direction of a shell base of the housing side wall, and in the angled state protruding beyond the shell base in question by a definable value. To allow the highest possible heat transfer from the single cell to the cooling plate, and/or simple electrical and thermal coupling of adjacent single cells in a cell block, at least one of the housing side walls of the cell housing has a section which protrudes beyond the flange area in parts and which is angled in the direction of the cell interior. Due to the resulting housing surface which is enlarged compared to conventional single cells, the heat transfer surface area is likewise enlarged, and thus allows improved cooling of the single cells.

In one possible embodiment of the invention, the housing side wall has a design protruding, at least in parts, beyond the flange area at two oppositely situated housing edges of the cell housing, the protruding sections being angled with respect to one another in the direction of the cell interior. Thus, two oppositely situated housing edges are used for heat transfer and resulting improved heat dissipation from the single cell.

The section of the housing side wall protruding beyond the flange area is advantageously angled at right angles or essentially at right angles with respect to the shell base. This allows a flat or essentially flat surface on which a conventional cooling plate may be easily situated.

The sections of adjacent housing side walls protruding beyond the flange area particularly preferably have different polarities corresponding to one another. Single cells adjacently situated in the cell block may thus be easily electrically contacted.

A battery according to the invention includes a plurality of single cells electrically connected to one another in series and/or parallel, the single cells, in particular flat cells, preferably being situated closely one behind the other and aligned in parallel to one another. An optimal installation space-saving arrangement of the single cells is thus achieved. Since cell poles of the single cells are situated on the housing side walls of the cell housing, the single cells are preferably electrically connectable to one another in series via a coupling of housing side walls having different polarities. In this way, optimal contacting of the single cells in the cell block is achievable, and manufacture of the battery is significantly simplified.

The single cells are particularly preferably situated next to one another in the cell block in such a way that the angled sections of the housing side walls of single cells adjacently arranged in the cell block protruding beyond the flange area are arranged in overlap with one another, at least in parts. The angled sections of the housing side walls protruding beyond the flange area may thus be used as a fastening element as well as a contacting element. Due to this design as a fastening element and a contacting element, as a molded part with the particular single cell, it is particularly advantageous that no additional separate components are necessary as fastening and contacting elements. This results in simplified manipulability of the battery during its assembly, as well as weight and cost savings. In addition, assembly time of the battery may be shortened.

The angled sections of the housing side walls of single cells adjacently arranged in the cell block protruding beyond the flange area are advantageously connected to one another in their overlap area in a form-fit, integrally bonded, and/or positive-fit manner. The angled sections may be joined by ultrasonic welding, for example. In the process, the welding tool, comprising the sonotrode that is moved at high frequency and the stationary anvil, engages around both of the angled sections of the adjacent housing side walls to be joined.

In order to uniformly introduce the mechanical pressure of a clamping means extending around the cell block into the cell block at the end face, a conventional pressure backstay is preferably situated in each case at the end side of the cell block.

The cell block is thermally coupled to at least one cooling plate, the cooling plate having a shape corresponding to the cell block and being situated on the cell block in a form-fit or positive-fit manner in the area of the overlappingly arranged sections of the adjacent housing side walls. The angled, overlappingly arranged sections of the adjacent housing side walls are preferably situated parallel to the cooling plate. In this way the heat may be easily and effectively dissipated with a high heat transfer surface area via the adjoining cooling plate, so that the single cells and thus the battery may be well temperature-controlled. Form-fit clamping, for example, may be used to fasten the cooling plate to the cell block.

The battery according to the invention, in particular a vehicle battery, is usable in a vehicle having a hybrid drive and/or in a vehicle operated with fuel cells, in particular for a motor vehicle for passenger transport.

### BRIEF DESCRIPTION OF THE DRAWING FIGURES

Exemplary embodiments of the invention are explained in greater detail below with reference to the drawings, which show the following:

FIG. 1 schematically shows an exploded illustration of a single cell having two housing side walls and a frame situated in between,

FIG. 2 schematically shows a sectional illustration of the single cell according to FIG. 1,

FIG. 3 schematically shows two single cells prior to an integrally bonded connection,

FIG. 4 schematically shows a perspective illustration of a weld of two single cells,

FIG. 5 schematically shows a side view of a weld of two single cells,

FIG. 6 schematically shows an exploded illustration of a cell block and the high-voltage contacts,

FIG. 7 schematically shows a perspective illustration of an end-face arrangement and a weld of the high-voltage contacts to the cell block,

FIG. 8 schematically shows an exploded illustration of a cell block, end-face pressure backstays, and clamping means,

FIG. 9 schematically shows an exploded illustration of a cell block with pressure backstays and clamping means mounted thereon, a thermally conductive foil, and a cooling plate,

FIG. 10 schematically shows a side view of a cell block with pressure backstays and clamping means mounted thereon, a thermally conductive foil, and a cooling plate,

FIG. 11 schematically shows an exploded illustration of a cell block with a cooling plate and tension clamps mounted thereon, and

FIG. 12 schematically shows a perspective illustration of a cell block with a cooling plate mounted thereon by means of a plurality of tension clamps.

Mutually corresponding parts are provided with the same reference numerals in all figures.

### DETAILED DESCRIPTION

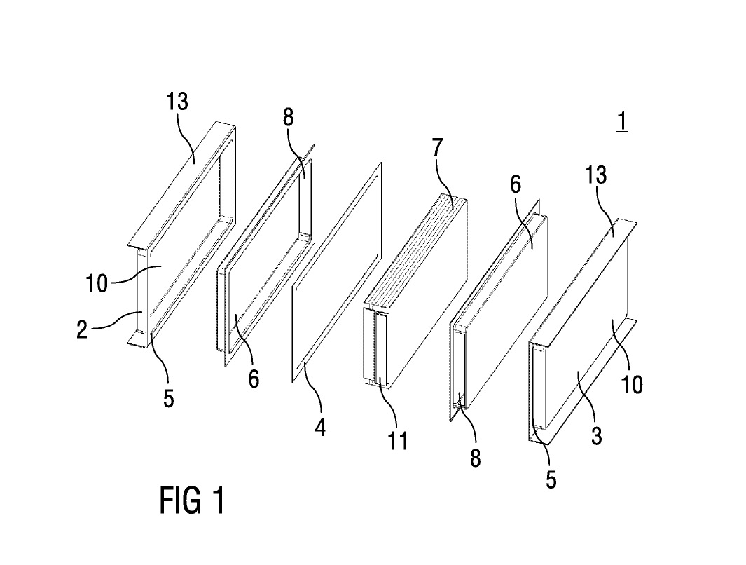

FIG. 1 schematically shows an exploded illustration of a single cell 1 having two housing side walls 2, 3 and a frame 4 situated in between. A cell housing of the single cell 1 includes two housing side walls 2, 3, a first housing side wall 2 and a second housing side wall 3. At least one of the housing side walls 2, 3 is designed as a half-shell, and the other housing side wall 2, 3 may be designed as a conventional enveloping metal sheet (not illustrated), designed as a flat plate, for example. In the illustrated example according to FIG. 1, both housing side walls 2, 3 have a shell-shaped design. The two housing side walls 2, 3 each have a shell flange 5 extending around the edges.

The frame 4 is situated between the two housing side walls 2, 3 for electrical insulation. The frame 4 has a design corresponding to the shell flange 5.

Situated at each housing side wall 2, 3 on the inner side of the single cell 1 is an insulation means 6 having a design corresponding to the particular housing side wall 2, 3. That is, the insulation means 6 likewise has a shell-shaped design whose dimensions correspond to those of the housing side wall 2, 3, the insulation means 6 essentially completely covering the particular housing side wall 2, 3 on the inner side of the single cell 1. The insulation means 6 has a recess 8 for electrically contacting an electrode stack 7 with the housing side wall 2, 3.

A cell interior 9 is formed by the shell-shaped design of the two housing side walls 2, 3 and a resulting spacing of the shell base 10 from the housing side walls 2, 3. The electrode stack 7 is situated within the cell interior 9. The distance between the two shell bases 10 preferably corresponds to the height of the electrode stack 7, thus allowing a compact design of the single cell 1.

The conventional electrode stack 7 is formed from electrode foils having different polarities. The electrode foils are electrically insulated from one another by means of a separator (not illustrated in greater detail), in particular a separator foil. As the result of one preferred design of the invention, the electrode stack 7 is formed from aluminum and/or copper foils stacked one on top of the other, and/or foils composed of a metal alloy.

The electrode foils of the electrode stack 7 having one polarity are contacted with electrically conductive current discharge tabs, which are assembled to form a pole contact tab 11 in particular by means of pressing and/or welding. Each pole contact tab 11 having one polarity is connected to a respective housing side wall 2, 3 in an electrically conductive manner in particular by welding, so that the two housing side walls 2, 3 act as electrical poles of the single cell 1.

For contacting the pole contact tab 11 with the particular housing side wall 2, 3, the insulation means 6 in each case has a recess 8. The dimensions of the recess 8 correspond to those of the pole contact tab 11.

In addition, the housing side walls 2, 3 are used as so-called heat conducting plates, by means of which heat generated within the single cell 1 in particular during charging and/or discharging may be dissipated.

During assembly of the single cell 1, the shell flanges 5 of the housing side walls 2, 3 are joined to one another in an integrally bonded manner to form a flange area 12, and are electrically insulated from one another by means of the frame 4. The two housing side walls 2, 3 are preferably joined by a heat sealing process. In the process, the frame 4, made of plastic having a low melting temperature, situated in the flange area 12 is partially melted in the heating press. The two housing side walls 2, 3 are joined together when the frame 4 solidifies upon a drop in temperature and/or under pressure.

According to the invention, at least one of the housing side walls 2, 3 has a design protruding, at least in parts, beyond the flange area 12 of at least one housing edge of the cell housing. The section 13 of the housing side wall 2, 3 protruding beyond the flange area 12 is angled in the direction of the cell interior 9 and in the direction of the shell base 10 of the particular housing side wall 2, 3. In the angled state, the section 13 protrudes beyond the shell base 10 by a predefinable value.

The particular housing side wall 2, 3 preferably has a design protruding, at least in parts, beyond the flange area 12 at two oppositely situated housing edges of the cell housing.

The section 13 of the particular housing side wall 2, 3 protruding beyond the flange area 12 is particularly preferably angled at right angles or essentially at right angles with respect to the shell base 10.

In one advantageous embodiment, the angled sections 13 of adjacent housing side walls 2, 3 protruding beyond the flange area 12 have different polarities corresponding to one another. For example, the sections 13 have different distances from the respective shell base 10, so that an overlapping arrangement of the sections 13 of adjacent housing side walls 2, 3 having different polarities is made possible.

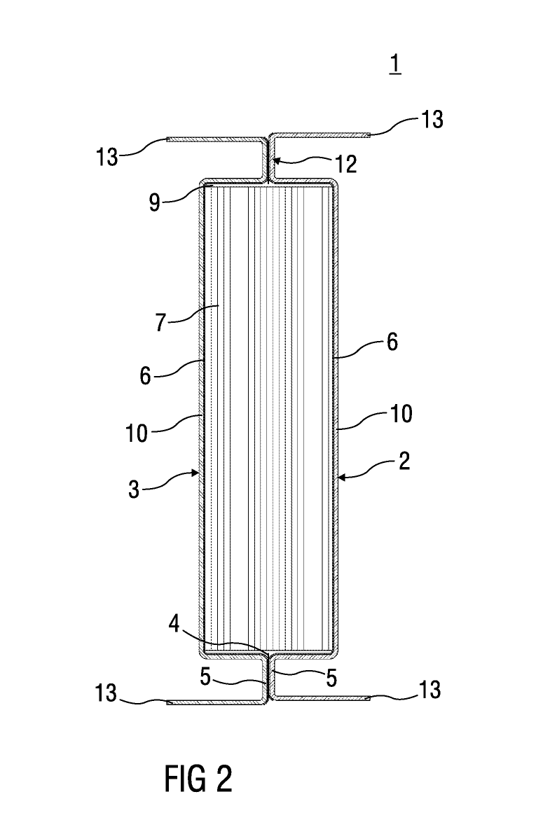

FIG. 2 schematically shows a sectional illustration of the single cell 1 according to FIG. 1.

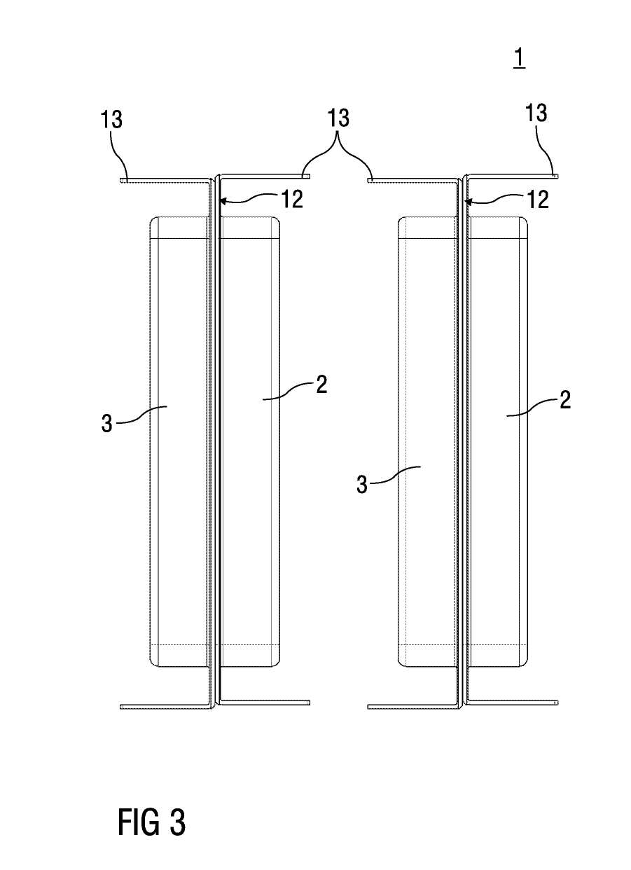

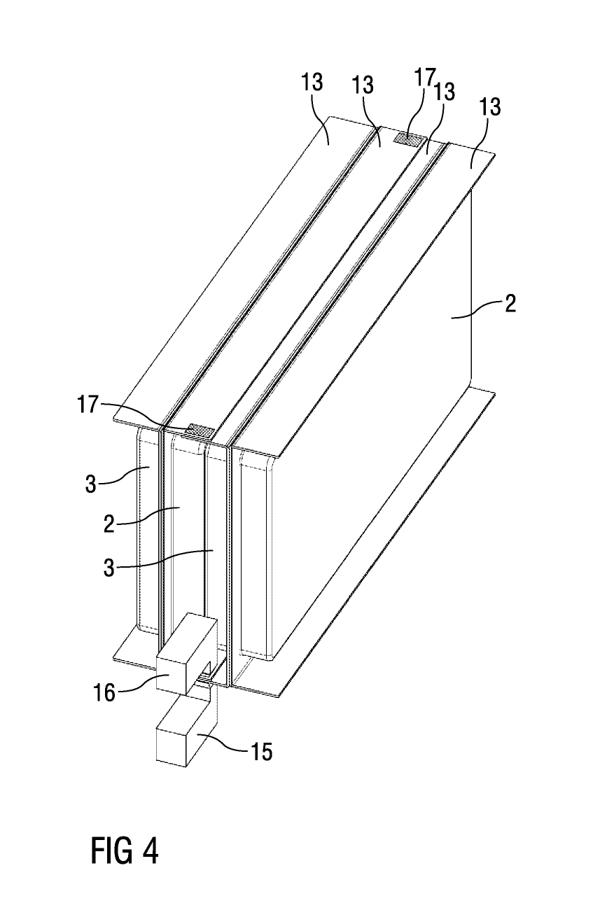

FIG. 3 schematically shows two adjacently situated single cells 1 prior to an integrally bonded connection, and FIG. 4 schematically shows a perspective illustration of a weld of two single cells 1 in the area of the angled sections 13.

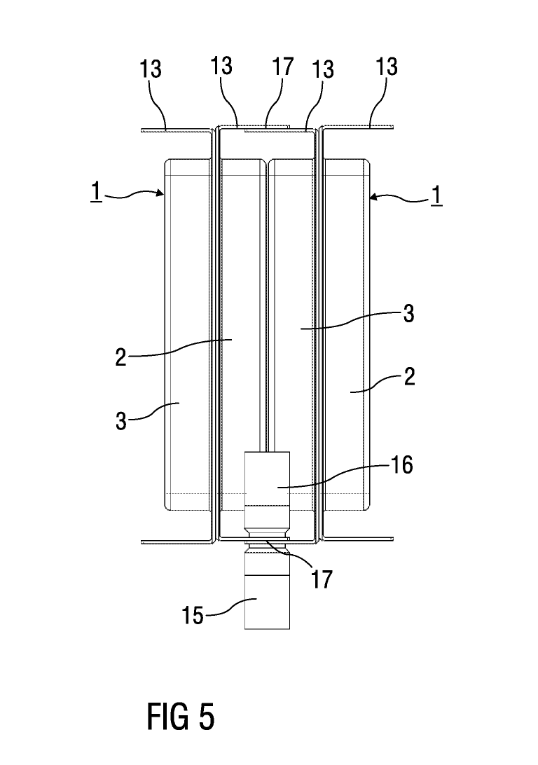

FIG. 5 schematically illustrates a side view of a weld of two single cells 1.

For producing a cell block 14 illustrated in FIG. 7, in the illustrated exemplary embodiment the single cells 1 are electrically connected to one another in series, in this series connection an electrical connection of the single cells 1 being established by contacting the sections 13 of directly adjacent single cells 1.

The single cells 1 are situated next to one another in the cell block 14 in such a way that the angled sections 13 of the housing side walls 2, 3 of single cells 1 adjacently arranged in the cell block 14 which protrude beyond the flange area 12 are arranged in overlap with one another, at least in parts. According to the overlapping arrangement of the angled sections 13 of the housing side walls 2, 3 of single cells 1 adjacently situated in the cell block 14, the angled sections are connected to one another in their overlap area in a form-fit, integrally bonded, and/or positive-fit manner, as illustrated in FIGS. 4 and 5.

The angled sections 13 are preferably connected in an integrally bonded manner, preferably by a conventional pressure welding process. In alternative embodiments, the connection may be a positive-fit connection, for example by conventional clinching or tox clinching, and/or in a positive-fit manner, for example by conventional riveting or screwing.

This type of connection of adjacent single cells 1 allows an electrical contact between the single cells 1, and the mechanical formation of a cell block 14 from multiple single cells 1. To improve the mechanical load capacity, the angled sections 13 may also be connected at the oppositely situated housing edge of the cell housing.

The angled sections 13 are particularly preferably joined by conventional ultrasonic welding. In the process, the welding tool, comprising the sonotrode 15 that is moved at high frequency and the stationary anvil 16, laterally engages with the gap that is present beneath the shell flanges 5. The sonotrode 15, which vibrates at a high frequency, is subsequently pressed against the anvil 16, thus pressing the overlappingly arranged angled sections 13 against one another, so that the angled sections 13 are locally melted or fused on due to frictional heat and pressed, forming an integrally bonded connection.

One or more weld seams and/or weld points 17 may be produced during the welding. One weld point 17 is particularly preferably produced on each side of the adjacent single cells 1.

The angled sections 13 overlappingly arranged in the longitudinal direction of the cell block 14 advantageously allow simple tolerance compensation of single cells 1 having different cell thicknesses; thus, uniform grid spacing in the cell block 14 may be set despite different cell thicknesses due to manufacturing tolerances, for example.

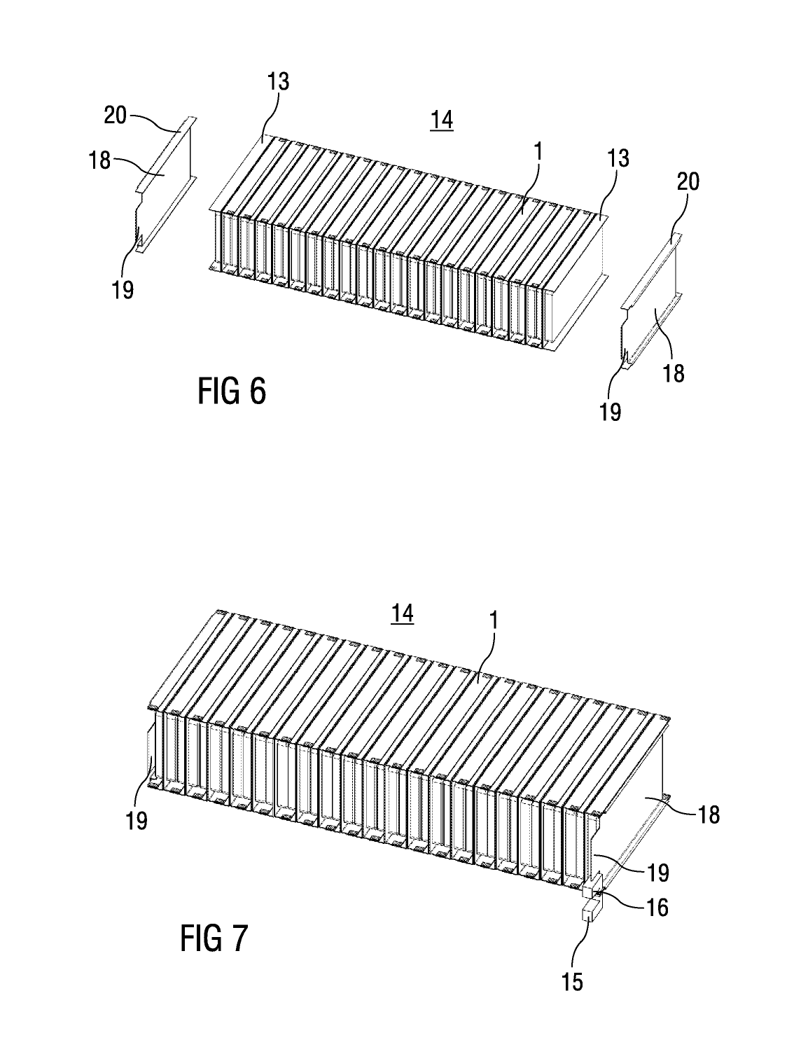

FIG. 6 schematically illustrates an exploded illustration of a cell block 14 and the high-voltage contacts 18.

FIG. 7 schematically shows a perspective illustration of an end-face arrangement and a weld of the high-voltage contacts 18 to the cell block 14.

For mechanically forming a cell block 14 comprising the single cells 1, the single cells 1 in the electrical series connection are situated next to one another. A high-voltage contact 18 is situated on each edge side, i.e., at the first and last single cell 1 of the cell block 14, and is designed as a high-voltage terminal of the battery, in particular for coupling same to electrical consumers (not illustrated in greater detail) and to an electrical system of the vehicle. For this coupling, the high-voltage contacts 18 each have a tab-like extension 19 protruding beyond the single cells 1 and is used as an electrical terminal contact.

The high-voltage contacts 18 are designed as embossed sheet metal parts, and have angled sections 20 that are shaped corresponding to the angled sections 13 of the single cells 1. In the end-side arrangement of the high-voltage contacts 18 on the cell block 14, the sections 20 of the high-voltage contact 18 and the sections 13 of the single cell 1 are overlappingly arranged, and are joined in an integrally bonded manner in the described manner.

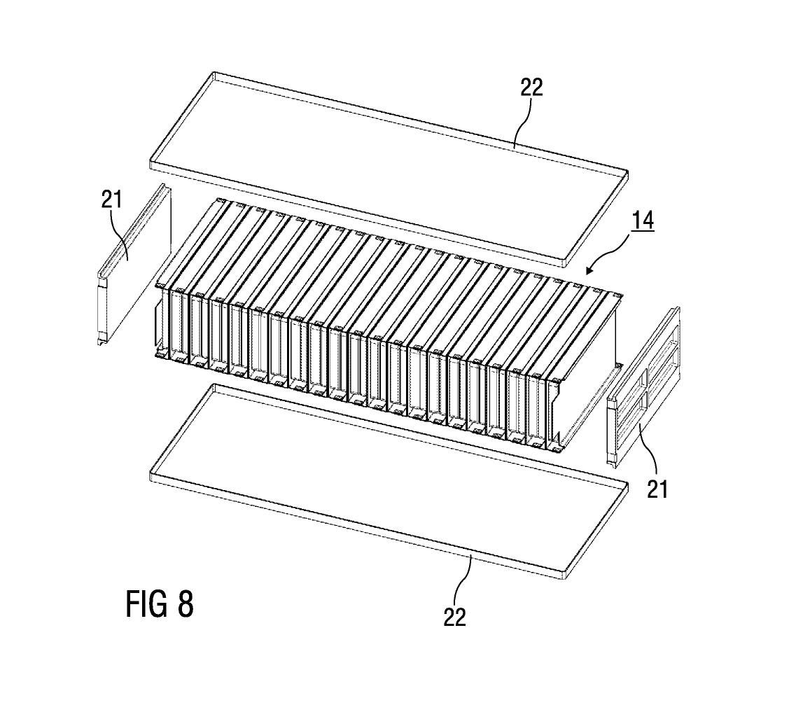

FIG. 8 schematically shows an exploded illustration of a cell block 14, end-face pressure backstays 21, and clamping means 22. To increase the mechanical stability of the cell block 14, in particular to avoid destruction of the cell block 14 in the event of a pressure rise in the cell interior 9 of the single cells 1, for example due to short-circuiting and/or overloading, the cell block 14 is pressed with conventional pressure backstays 21 and at least one clamping means 22 which extends around the cell block and the pressure backstays 21. The clamping means 22 is preferably designed as a conventional tensioning band. The pressure backstays 21, which are situated on the end side of the cell block 14 and have a shape corresponding to same, allow uniform introduction of the mechanical pressure, applied by the clamping means 22, into the cell block 14.

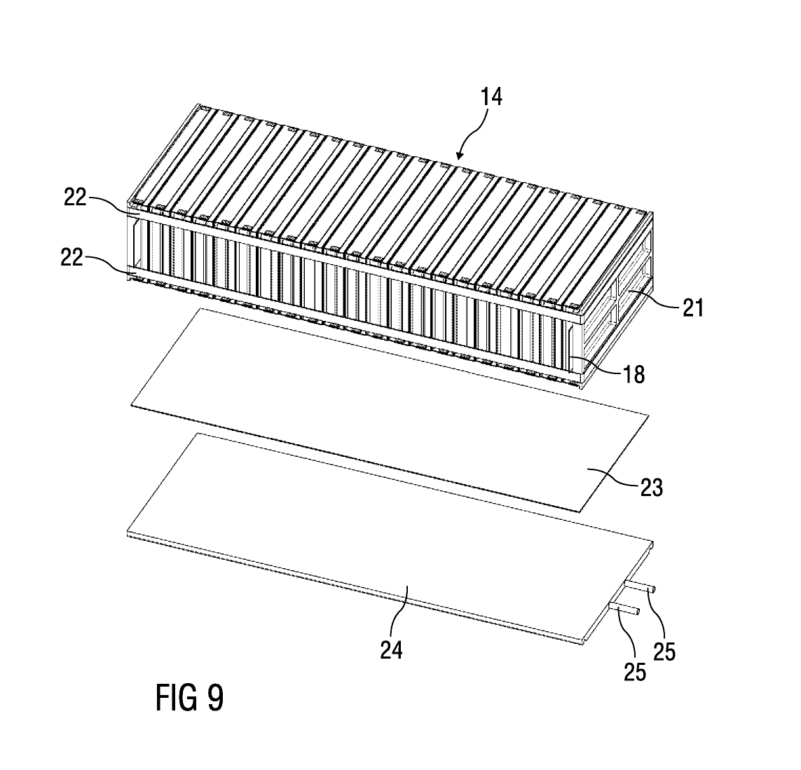

FIG. 9 schematically shows an exploded illustration of a cell block 14 with pressure backstays 21 and clamping means 22 mounted thereon, a thermally conductive foil 23, and a cooling plate 24. For discharging heat loss which results during operation of the cell block 14 and which occurs in particular during the charging and discharging processes, the cell block 14 is coupled to the cooling plate 24 in a thermally conductive manner.

Since the cooling plate 24 is preferably made of a material having very good thermal conductivity, and therefore in particular a metallic material, an electrically insulating and thermally conductive material, in the illustrated exemplary embodiment a thermally conductive foil 23, is preferably introduced between the cell block 14 and the cooling plate 24.

The cooling plate 24 has inner channels, not illustrated, through which a cooling medium flows. For a high level of dissipation, a cooling medium, for example a refrigerant of a vehicle air conditioning system, flows through the cooling plate 24, the cooling plate 24 having connecting elements 25 for integration into a cooling circuit of this type.

The cooling plate 24 is situated on the cell block 14 in the area of the angled sections 13 of the single cells 1, and is thermally coupled to the sections 13. In the illustrated exemplary embodiment, the cooling plate 24 is situated on the bottom side of the cell block 14.

In an embodiment not illustrated, a second cooling plate 24 may be situated on the top side of the cell block 14.

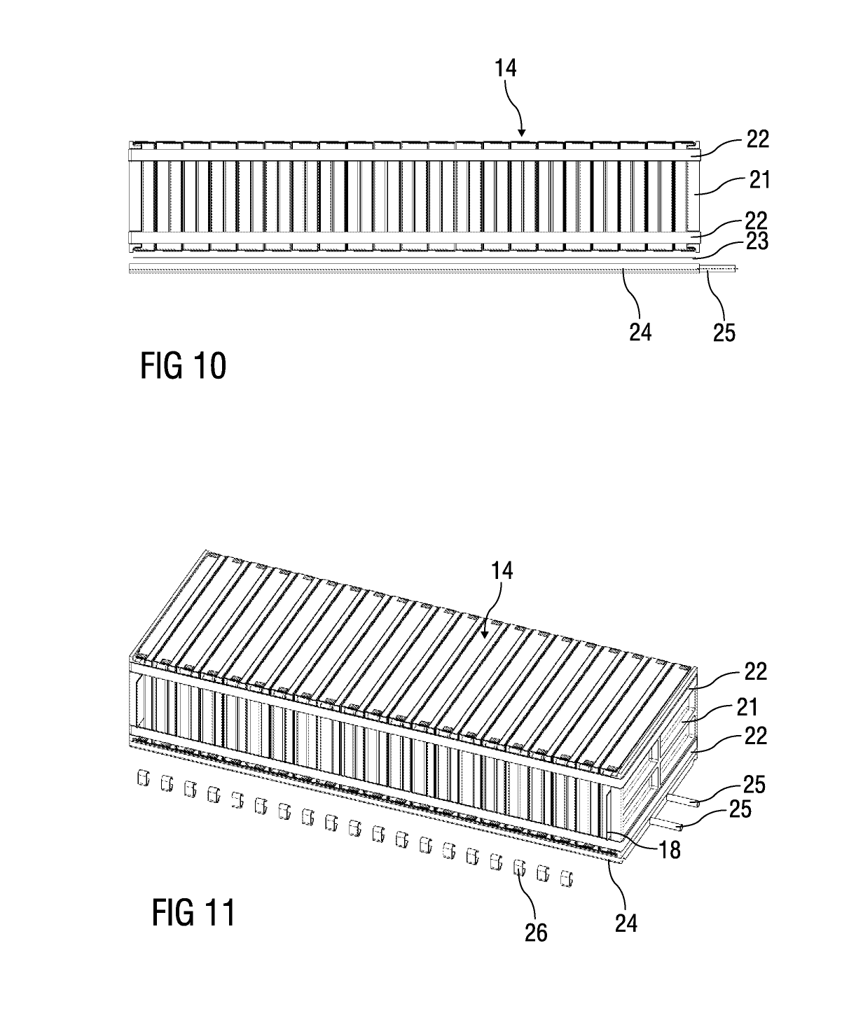

FIG. 10 schematically shows a side view of a cell block 14 with pressure backstays 21 and clamping means 22 mounted thereon, the thermally conductive foil 23, and a cooling plate 24.

FIG. 11 schematically shows an exploded illustration of a cell block 14 with a cooling plate 24 and tension clamps 26 mounted thereon.

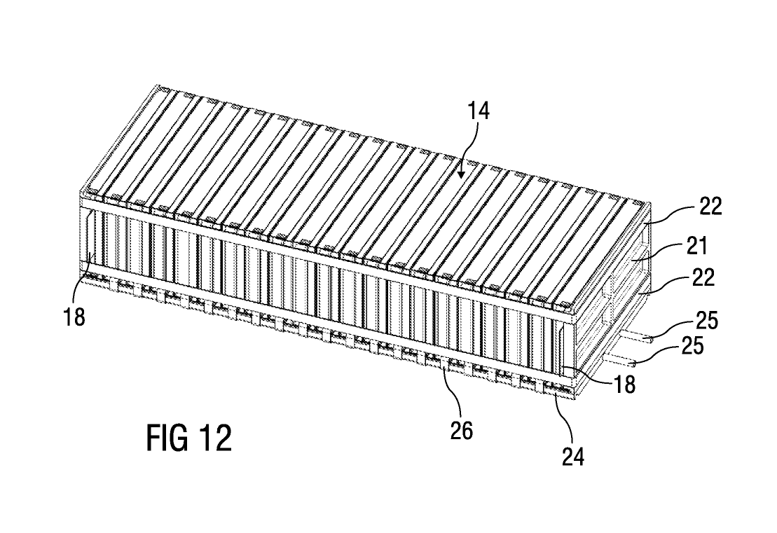

FIG. 12 schematically illustrates a perspective illustration of a cell block 14 with a cooling plate 24 mounted thereon by means of a plurality of tension clamps 26. The cooling plate 24 is fastened to the cell block 14 by means of a plurality of conventional tension clamps 26 for the reversible mechanical and thermal coupling of the cell block 14 to the cooling plate 24. The tension clamps 26 engage with correspondingly shaped recesses and/or grooves, not illustrated in greater detail, in the cooling plate 24 and the cell block 14, and press the cooling plate 24 and cell block 14 together.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Single cell
2 First housing side wall
3 Second housing side wall
4 Frame
5 Shell flange
6 Insulation means
7 Electrode stack
8 Recess
9 Cell interior

10 Shell base
11 Pole contact tab
12 Flange area
13 Section
14 Cell block
15 Sonotrode
16 Anvil
17 Weld point
18 High-voltage contact
19 Extension
20 Angled section
21 Pressure backstay
22 Clamping means
23 Thermally conductive foil
24 Cooling plate
25 Connecting element
26 Tension clamp

1-10. (canceled)

11. A single cell for a battery, comprising:
an electrode stack;
a cell housing in which the electrode stack is situated, wherein the cell housing is formed from first and second electrically conductive shell-shaped housing side walls situated in parallel opposite one another, each of the first and second electrically conductive shell-shaped housing side walls having a shell flange extending around edges of the first and second electrically conductive shell-shaped housing side walls,
wherein the shell flanges of the first and second electrically conductive shell-shaped housing side walls are joined to one another in an integrally bonded manner to form a flange area and each of the first and second electrically conductive shell-shaped housing side walls being electrically insulated from one another,
wherein pole contact tabs of the electrode stack are electrically connected to the first and second electrically conductive shell-shaped housing side walls,
wherein at least one of the first and second electrically conductive shell-shaped housing side walls has a section protruding, at least in parts, beyond the flange area of at least one housing edge of the cell housing, wherein the protruding section of the at least one of the first and second electrically conductive shell-shaped housing side walls is angled in a direction of a cell interior and in a direction of a shell base of the first and second electrically conductive shell-shaped housing side walls, and in the angled state protruding beyond the shell base by a predetermined amount.

12. The single cell according to claim 11, wherein the protruding section of the at least one of the first and second electrically conductive shell-shaped housing side walls protrudes, at least in parts, beyond the flange area at two oppositely situated housing edges of the cell housing.

13. The single cell according to claim 10, wherein the protruding section of the at least one of the first and second electrically conductive shell-shaped housing side walls is angled at right angles with respect to the shell base.

14. The single cell according to claim 10, wherein both of the first an second electrically conductive shell-shaped housing side walls includes the protruding section, and each of the protruding sections have different polarities.

15. A battery, comprising:
a plurality of single cells, each of the plurality of single cells comprising
an electrode stack;
a cell housing in which the electrode stack is situated, wherein the cell housing is formed from first and second electrically conductive shell-shaped housing side walls situated in parallel opposite one another, each of the first and second electrically conductive shell-shaped housing side walls having a shell flange extending around edges of the first and second electrically conductive shell-shaped housing side walls,
wherein the shell flanges of the first and second electrically conductive shell-shaped housing side walls are joined to one another in an integrally bonded manner to form a flange area and each of the first and second electrically conductive shell-shaped housing side walls being electrically insulated from one another,
wherein pole contact tabs of the electrode stack are electrically connected to the first and second electrically conductive shell-shaped housing side walls,
wherein at least one of the first and second electrically conductive shell-shaped housing side walls has a section protruding, at least in parts, beyond the flange area of at least one housing edge of the cell housing, wherein the protruding section of the at least one of the first and second electrically conductive shell-shaped housing side walls is angled in a direction of a cell interior and in a direction of a shell base of the first and second electrically conductive shell-shaped housing side walls, and in the angled state protruding beyond the shell base by a predetermined amount,
wherein the plurality of single cells are electrically connected to one another in series or parallel.

16. The battery according to claim 15, wherein the plurality of the single cells are situated next to one another in a cell block in such a way that the angled sections of the housing side walls of single cells adjacently arranged in the cell block which protrude beyond the flange area are arranged in overlap with one another, at least in parts.

17. The battery according to claim 16, wherein the angled sections of the housing side walls of the single cells adjacently arranged in the cell block which protrude beyond the flange area are connected to one another in their overlap area in a form-fit, integrally bonded, or positive-fit manner.

18. The battery according to claim 16, further comprising:
a pressure backstay situated at each end of the cell block.

19. The battery according to claim 18, further comprising:
a at least one circumferential clamping situated around the cell block and pressure backstays.

20. The battery according to claim 16, further comprising:
a cooling plate thermally coupled to the cell block, wherein the cooling plate has a shape corresponding to the cell block and is arranged on the cell block in a form-fit or positive-fit manner in the area of the overlappingly arranged sections of the adjacent housing side walls.
